(19) United States
(12) Patent Application Publication
(10) Pub. No.: US 2012/0014675 A1
(43) Pub. Date: Jan. 19, 2012

(54) Method and Device for Storing a Portion of a Video Stream

(75) Inventors: Florent Previtali, Pontault-Combault (FR); Thomas Bouton, Sant Mande (FR)

(73) Assignee: STREAMWIDE, Paris (FR)

(21) Appl. No.: 13/260,013

(22) PCT Filed: Mar. 23, 2011
(86) PCT No.: PCT/FR2010/050529

§ 371 Date: Sep. 23, 2011

(30) Foreign Application Priority Data
Mar. 24, 2009 (FR) 0951897

(51) Int. Cl. H04N 5/917

(52) U.S. Cl. 386/328; 386/E05.007

(57) ABSTRACT

The invention relates to a method for storing a portion of a compressed video stream, said compressed video stream comprising a series of compressed key images between which are inserted intermediate frames comprising at least the encoding of differences between an uncompressed intermediate image and the key image immediately preceding same, said method comprising: acquiring, in real time, the compressed video stream; temporarily storing, without decompression, the acquired compressed video stream, said temporary storage comprising at least the last compressed key image received and the subsequent intermediate frames; upon receipt of a permanent storage start event at a given instant: reconstructing a compressed key image corresponding to said given instant starting from the last key image received and from the subsequent intermediate frames; and storing the portion of the video stream starting with the reconstructed compressed key image.

The present invention relates to a method and a device for storing a portion of a compressed video stream and to a computer program product for implementing the method.

At present, among the video stream compression methods used, the most widely used compression encoding is that defined by the MPEG working group, more particularly in the ISO/IEC 13818-MPEG-2 and ISO/IEC 14496-MPEG-4 standards. These two standards are very similar in the compression principles used: certain images are stored and compressed at regular intervals and, for the intermediate images, only the differences are stored and encoded.

More precisely, the MPEG compression uses an estimation of movement. The MPEG encoding breaks down each image into blocks called macroblocks, and examines the adjacent images to see if there are similar blocks. If a correspondence is found, rather than storing the entire block, the system stores a much smaller vector describing how the block has moved (or not moved) between the images. The vectors are encoded such that they can use only a single bit in certain cases which means that the backgrounds and other elements which do not move over time are compressed very efficiently. Similarly, large groups of blocks which move together, such as a large object or scrolling of the entire image, are also efficiently compressed.

MPEG uses three types of image encoding methods.

Intra-frames, or I frames, in which an entire image is compressed and stored with a DCT (Discrete Cosine Transform) quantification. This creates a reference image on the basis of which the following images are constructed. These I frames also allow random access in the video stream and, in practice, are generated about every half-second.

Predictive frames, or P frames, contain movement vectors describing the difference after the I frame or the closest preceding P frame.

The frames of the third type are the bidirectional frames or B frames. The system looks forward or backward in order to find corresponding blocks. In this way, if something new appears in a B frame, it can be paired with a block of the next I or P frames. It can therefore be understood that, statistically, the P and B frames are much smaller than the I frames.

As mentioned above, a compressed video stream can only start on an I frame serving as a first reference image on the basis of which the following P or B frames will be constructed. As stated above, these I frames are also used for random access to the video stream. However, it is understood that a problem arises when it is desired to record, or store, only a portion of the video stream, with a random start, and therefore not necessarily corresponding with an I frame.

In order to solve this problem, the current recording systems continuously decode the compressed video stream so that, when the user of the system decides to start a recording, the decompressed image corresponding to this start of recording is encoded again in the form of an I frame. The following frames are then re-encoded on the basis of this I frame or, if the encoding so allows, the following B or P frames are retained but as differential images of the reconstructed I image. For the best-performance systems, and in order not to lose quality due to encoding followed by re-encoding, the system also detects the first I frame of the incoming compressed video stream following the start of the recording and, starting from this frame, stores the incoming compressed video stream without transformation.

This solution has the drawback of imposing a continuous decoding of the incoming compressed video stream whilst waiting for the instruction to start recording. This drawback is not important when the apparatus is connected to a display device so that the user can view the incoming compressed video stream in real time since the decoding then has to be carried out for the display. On the other hand, in systems not requiring this decoding for display, this becomes extremely penalizing in terms of machine resources.

It would also be particularly advantageous to have a method and a device for storing a portion of compressed video stream allowing a minimizing of computing resources.

Therefore, according to an aspect of the invention, a method for storing a portion of a compressed video stream, said compressed video stream comprising a series of compressed key images between which are inserted intermediate frames comprising at least the encoding of differences between an uncompressed intermediate image and the immediately preceding compressed key image, comprises: acquiring, in real time, the compressed video stream,
temporarily storing, without decompression, the acquired compressed video stream, said temporary storage comprising at least the last compressed key image received and the subsequent intermediate frames,
upon receipt of a permanent storage start event at a given instant:
reconstructing a compressed key image corresponding to said given instant on the basis of said last compressed key image received and the subsequent intermediate frames,
storing the portion of the video stream starting with the reconstructed compressed key image.

According to a particular embodiment, when the temporary storage of the video stream exceeds a predetermined storage size, a compressed key image is reconstructed from said last compressed key image received and from the subsequent intermediate frames and then the last compressed key image received is replaced in the temporary storage by the reconstructed compressed key image.

According to another particular embodiment, the compressed video stream is a video stream encoded according to one of the ISO/IEC 13818-MPEG 2, ISO/IEC 14496—MPEG-4 and H264 standards.

According to a second aspect of the invention, a computer program product comprises program code instructions recorded on a medium that can be read by a computer, in order to implement the steps of the above method when said program is running on a computer.

According to a third aspect of the invention, a device for storing a portion of a compressed video stream, said compressed video stream comprising a series of compressed key images between which are inserted intermediate frames comprising at least the encoding of differences between an uncompressed intermediate image and the immediately preceding key image, comprises:
means of acquiring, in real time, the compressed video stream,
means of receiving a permanent storage start event at a given instant, connected to triggering means:
means of storing the portion of video stream starting from the given instant, characterized in that it moreover comprises
means of temporarily storing, without decompression, the acquired video stream, said temporary storage means comprising at least the last compressed key image received and the subsequent intermediate frames, and
means of reconstructing a compressed key image corresponding to said given instant on the basis of said last compressed key image received and the subsequent intermediate frames such that the portion of the video stream stored starts with said reconstructed compressed key image.

The invention will be better understood on reading the following description, given solely by way of example and with reference to the attached figures in which:

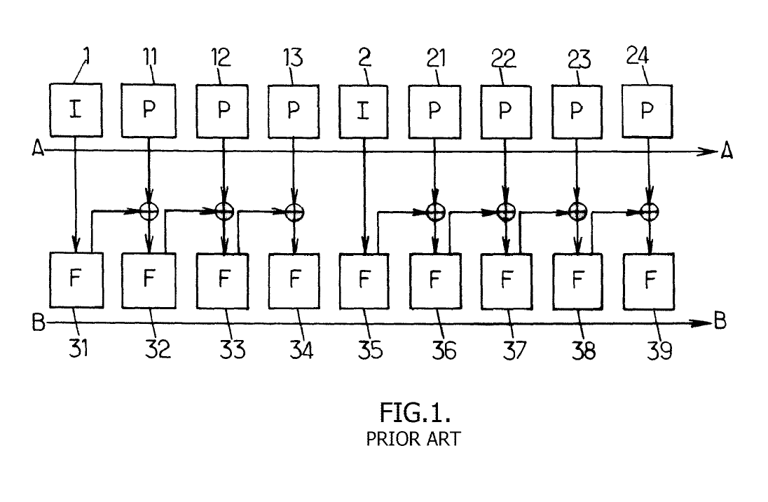

FIG. 1 is a block diagram of an example of a method for storing video stream according to the prior art;

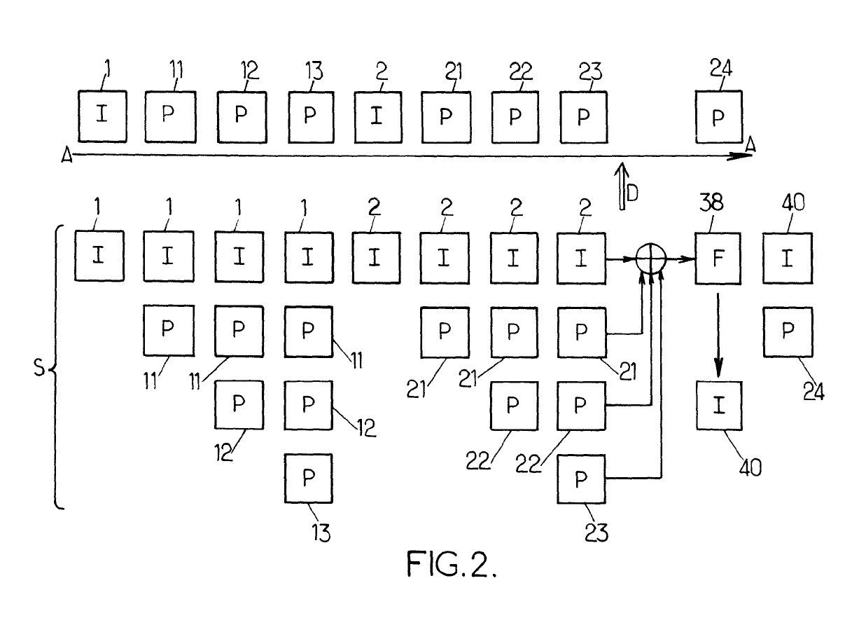

FIG. 2 is a block diagram of an example of a storing method according to an embodiment of the invention;

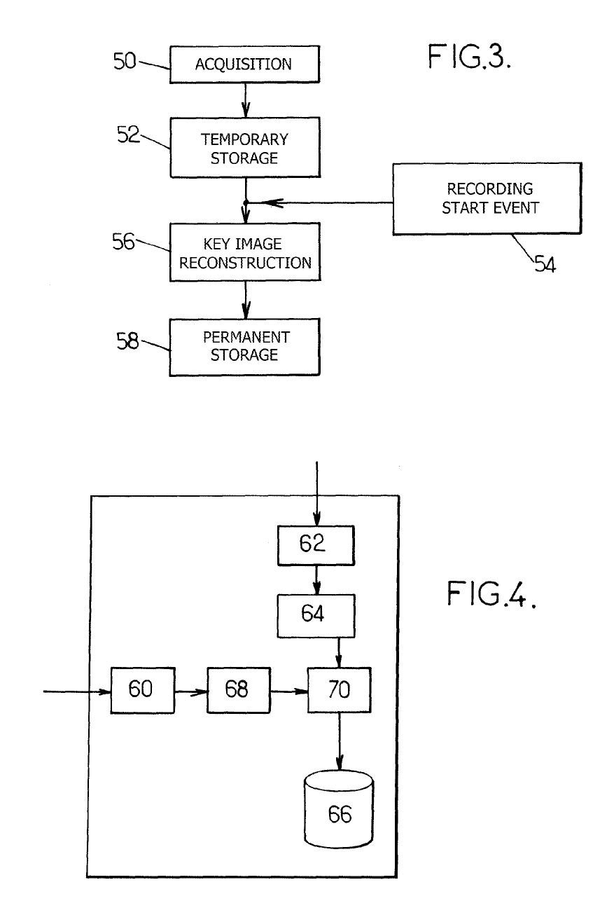

FIG. 3 is a flowchart of a storing method according to an embodiment of the invention; and

FIG. 4 is a block diagram of a storage device according to an embodiment of the invention.

FIG. 1 represents a video stream in the MPEG format comprising two compressed I images (in other words, two I frames) referenced 1 and 2 along a time axis AA. The compressed I image I 1 is therefore prior to the compressed I image I 2.

Between these compressed I images are inserted P frames 11, 12, 13, 21, 22, 23 and 24.

The corresponding stream is symbolized on the axis BB, in the form of a stream of decoded F images 31 to 39.

Thus, in a standard fashion, the decoded F image F 31 is obtained by decompressing the compressed I image I 1 and the decoded F image F 35 is obtained by decompressing the compressed I image I 2. The F image F 32 is obtained by modification of the F image F 31 as a function of the movement vectors contained in the P frame P 11, this modification being symbolized by the sign “+” in FIG. 1. The F image F 33 is obtained by modification of the F image F 32 as a function of the movement vectors contained in the P frame P 12 and so on for the decoded images corresponding to the P frames of the encoded video stream.

FIG. 2 shows, in its upper section, the same encoded video stream as that of FIG. 1 with the same references.

At any time, a record request D is triggered by a user. By way of illustration, the record request D occurs temporally between the P frames 23 and 24.

The lower section of FIG. 2 represents the content of a temporary storage zone S.

The frames are stored as they arrive and the temporary storage S is reset to zero at each arrival of a compressed I image.

Thus, the storage contains the compressed image I 1, then the frames I 1 and P 11, then the frames I 1, P 11 and P 12 then the frames I 1, P 11, P 12 and P 13. When the compressed image I 2 arrives, the temporary storage S is emptied and only the compressed image I 2 remains stored, and so on.

When the record request D is received, the temporary storage S therefore contains the compressed image I 2 and the frames P 21, P 22 and P 23.

The latter are combined in order to obtain the decoded image F 38 as explained above, the latter then being re-encoded as a compressed I image 40.

The frame P 24 which contains the differences between the images F 38 and F 39 therefore also contains the movement vectors making it possible to decode the image F 39 from the image I 40.

Then the continuation of the video stream is recorded without any transcoding operation.

Thus, the storage method, as shown in FIG. 3, consists in:
acquiring (step 50) the compressed video stream in real time and in
storing it (step 52) temporarily, without decompression such that the storage comprises at least the last compressed I image, or key image, acquired and the subsequent intermediate P and B frames.

Thus, when a start recording, or in other words permanent storage, event is received (step 54), a key image is reconstructed (step 56) from the last key images and the intermediate images received in order to obtain a key image corresponding to the start of recording instant and then the video stream is stored (step 58) without modification, i.e. without any decoding encoding operation.

In order to carry out this method, it is possible to produce a dedicated machine comprising, as shown in FIG. 4:
means 60 of acquiring the compressed video stream in real time;
means 62 of receiving a permanent storage start event at a given instant, connected to triggering means 64, such as for example a push button allowing a user to indicate a permanent storage start event by means of a single push; and
means 66 of storing the portion of video stream starting from the given instant. This dedicated machine also comprises:
means 68, of temporary storage, without decompression, of the acquired video stream, adapted for storing at least the last key image received and the subsequent intermediate frames; and
means 70 of reconstructing a key image corresponding to the start of storage instant from the frames stored in the temporary storage means 68, such that the portion of video stream stored in the storage means 66 begins with this key image.

This dedicated machine comprises a mixture of hardware and software.

Thus, for example, the temporary storage means 68 are composed of RAMs (Random Access Memories), or even of memories of the FIFO (First In First Out) type, in order to allow rapid access to the stored data, and the storage means 68 are composed of hard disks, magnetic tapes or optical disks providing high capacity permanent storage.

The reconstruction means can be produced using a combination of a microprocessor and software. Speed requirements can however prompt those skilled in the art to use a signal processing processor programmed by software or a logic circuit in which the functions are implemented in the form of a network of logic gates.

In general, the software is in the form of a computer program product comprising program code instructions recorded on a medium that can be read by a computer, in order to implement the steps of the described storage method.

A variant implementation of this method consists, in the context of a compromise between the size of the temporary storage and the computing means used, in reconstructing a key image form the images contained in the temporary storage as soon as the temporary storage of the images exceeds a predetermined storage size and then in retaining only that reconstructed key image in the temporary storage together with the subsequent intermediate images. It will be understood that this operation makes it possible to reduce the size of the temporary storage to the detriment of an additional reconstruction operation.

The invention has been illustrated and described in detail in the drawings and the above description. The latter must be considered as illustrative and given by way of example and not as limiting the invention to this description alone. Many variant embodiments are possible.

For example, other standards such as the H264 standard are suitable for the using the described method.

Similarly, after the reconstruction of the I image corresponding to the start of recording, the encoding of the immediately following frames can necessitate re-encoding them so that they comprise the differences with the reconstructed I image.

In the claims, the word “comprising” does not exclude other elements and the indefinite article “a” does not exclude a plurality.

1. A method for storing a portion of a compressed video stream, the compressed video stream comprising a series of compressed key images between which are inserted intermediate frames comprising at least the encoding of differences between an uncompressed intermediate image and the immediately preceding compressed key image, the method comprising:
acquiring, in real time, the compressed video stream;
temporarily storing, without decompression, the acquired compressed video stream, the temporary storage comprising at least the last key image received and the subsequent intermediate frames,
upon receipt of a permanent storage start event at a given instant:
reconstructing a key image corresponding to the given instant on the basis of the last key image received and the subsequent intermediate frames, and
storing the portion of the video stream starting with the reconstructed key image.

2. The method according to claim 1, wherein, when the temporary storage of the video stream exceeds a predetermined storage size, a compressed key image is reconstructed from the last compressed key image received and from the subsequent intermediate frames and then the last compressed key image received is replaced in the temporary storage by the reconstructed compressed key image.

3. The method according to claim 1, wherein the compressed video stream is a video stream encoded according to one of the ISO/IEC 13818-MPEG 2, ISO/IEC 14496 - MPEG-4 and H264 standards.

4. A computer program product comprising program code instructions recorded on a medium that can be read by a computer, in order to implement the following steps, when the program is running on a computer, for storing a portion of a compressed video stream, the compressed video stream comprising a series of compressed key images between which are inserted intermediate frames comprising at least the encoding of differences between an uncompressed intermediate image and the immediately preceding compressed key image;
acquiring, in real time, a compressed video stream;
temporarily storing, without decompression, the acquired compressed video stream, the temporary storage comprising at least the last key image received and the subsequent intermediate frames; and
upon receipt of a permanent storage start event at a given instant;
reconstructing a key image corresponding to the given instant on the basis of the last key image received and the subsequent intermediate frames, and
storing the portion of the video stream starting with the reconstructed key image.

5. A device for storing a portion of a compressed video stream, the compressed video stream comprising a series of compressed key images between which are inserted intermediate frames comprising at least the encoding of differences between an uncompressed intermediate image and the immediately preceding key image, the device comprising:
means of acquiring, in real time, the compressed video stream,
means of receiving a permanent storage start event at a given instant, connected to triggering means,
means of storing the portion of video stream starting from the given instant,
means of temporarily storing, without decompression, the acquired compressed video stream, the temporary storage means comprising at least the last compressed key image received and the subsequent intermediate frames, and
means of reconstructing a compressed key image corresponding to said the given instant on the basis of said the last compressed key image received and the subsequent intermediate frames such that the portion of the video stream stored starts with the reconstructed compressed key image.
